(19) United States
(12) Patent Application Publication
(10) Pub. No.: US 2015/0184407 A1
(43) Pub. Date: Jul. 2, 2015

(54) EQUIPMENT FOR LIFTING AND LOWERING AN OBJECT OF LARGE DIMENSIONS AND MASS

(71) Applicant: Konecranes Plc, Hyvinkää (FI)

(72) Inventor: Jari Kaiturinmäki, Hyvinkaa (FI)

(73) Assignee: KONECRANES PLC, Hyvinkää (FI)

(21) Appl. No.: 14/419,887

(22) PCT Filed: Sep. 3, 2013
(86) PCT No.: PCT/FI2013/050847

§ 371 Date: Feb. 5, 2015

(30) Foreign Application Priority Data
Sep. 7, 2012 (FI) 20125926

(51) Int. Cl. E04H 3/14; B66F 7/02; E04H 3/28; B66F 3/46

(52) U.S. Cl. CPC E04H 3/14; B66F 3/46; B66F 7/02; E04H 3/28; E04H 2003/142

(57) ABSTRACT

Equipment for lifting and lowering a platform in the middle of a large construction is provided, whereby the construction comprises a stationary, fixed, lower platform and an upper platform arranged thereabove and having an adjustable height position, the lifting equipment including a plurality of lifting pylons locating on the sides of the platforms, a lifting rope arrangement arranged for each lifting pylon and connected to the upper platform, and lifting machines connected to the lifting rope arrangements for lifting and lowering the upper platform. The lifting machine driving the lifting rope arrangement disposed in each lifting pylon is placed on the sides of the platforms opposite the lifting pylon concerned and below the level of the lower platform.

### BACKGROUND OF THE INVENTION

The invention relates to equipment for lifting and lowering a platform in the middle of a large construction, whereby the construction comprises a stationary, fixed, lower platform and an upper platform arranged thereabove and having an adjustable height position, the lifting equipment comprising a plurality of lifting pylons locating on the sides of the platform, a lifting rope arrangement arranged for each lifting pylon and connected to the upper platform, lifting machines connected to the lifting rope arrangements for lifting and lowering the platform by means of the lifting rope arrangements, and means for locking the upper platform into place at a desired height position.

A structure of this kind enables simultaneous employment of the same construction for different events or games. On one platform it is possible to arrange, for instance, an exhibition event, while on another platform, for instance, a team game is played at the same time. In a case when a larger number of people attend one event, the upper platform may be lowered on top of the lower platform, whereby the capacity of the whole construction may be utilized for this purpose. For instance, some of the official sports events require a non-covered structure, whereas some may be carried out in covered premises.

Prior art knows solutions, in which a large construction is moved horizontally completely aside by means of rolls, whereby the space occupied by it will be available for another purpose. Especially in terms of space efficiency this is a very poor solution, not to mention the technical problems involved.

A subsequent, more advanced solution over the previous one is disclosed, for instance, in U.S. Pat. No. 5,103,600, in which an upper level of a large construction is lifted hydraulically, or by means of counterweights, to be above a lower level at a desired height. Hydraulic structures and counterweight structures are bulky, costly and slow to use. Corresponding solutions are also disclosed in ES patent 2,294,909 and publication JP 5272246, for instance.

EP application 1249539 A2 discloses a bulky arena structure, in which a bulky bridge assembly is provided above the arena for lifting an upper level of the arena, which bridge assembly is arranged to comprise hoist roping for lifting the upper level. In addition to the structure being extremely complex, in this case to lift and support the upper level into place, presumably only to one specific height, is a very demanding task.

Structures technically most closely related to the initially defined starting point of the invention are disclosed, for instance, in publications WO 01/78497 A1, JP 84335 and JP 7139040. In these disclosed structures the upper level is not lifted, however, for any actual use loading the upper level. Instead, the upper level to be lifted according to said WO publication is intended for lighting which is arranged on the lower surface of the upper level and which is to improve the growth of the grass on the lower level. In JP publications, in turn, the upper level is intended for a different game than the lower level. In that case, the lower level may be provided, for instance, for baseball and the upper level for football. The levels cannot be used simultaneously, but for baseball the upper level is lifted off the lower level, whereas for football the upper level is lowered onto the lower level.

In the last-described prior art solutions, the upper level is thus not loaded simultaneously with different events, in which case the upper level should also sustain substantially the same load as the lower level. In that case the structure of the upper level would also be considerably bulkier, whereby the total masses to be lifted are of totally different order than in this prior art.

### SUMMARY OF THE INVENTION

Because the lifting-rope-based solutions known in the field do not offer a solution for lifting large masses, the object of the present invention is, starting from the prior art, to provide an arrangement of the earlier mentioned type, in which both the upper platform and the lower platform may be loaded simultaneously, yet avoiding bulky supplementary structures for actual lifting. This object is achieved by equipment of the invention which is mainly characterized in that lifting machinery driving a lifting rope arrangement arranged in each lifting pylon is disposed, in relation to the lifting pylon concerned, on the opposite side of the platforms and below the level of a lower platform.

Preferably the lifting machinery driving the lifting rope arrangement arranged in each lifting pylon is placed in the vicinity of a lifting pylon locating always on the opposite side of the platforms concerned, for instance, behind it or below it.

When the lifting machines are located in the above-described manner at a sufficient distance from sheaves to be arranged in the lower parts of the lifting pylons, the operability in winding a lifting rope on a drum and the service life of the lifting rope do not suffer from disadvantageous rope angles, whereby the rope drum comprised by the lifting machinery may be made an integral part of the lifting machinery.

When each lifting rope arrangement preferably comprises a lifting rope, a winch having an upper rope pulley set and a lower rope pulley set, the upper rope pulley set locating above an uppermost locking point of an upper platform, and the above-mentioned sheave, which is located below the level of a lower platform and guides the lifting rope towards the lifting machinery on the opposite side of the platforms, it is particularly advantageous that at each lifting point of the upper platform there is a pair of lifting pylons, each consisting of two lifting pylons interconnected by means of lifting rope arrangements disposed therein in such a way that the lower rope pulley sets of the winches are interconnected through a rope tension equalizer, the opposite ends of which are guided to move in vertical gaps provided in lifting pylon walls facing one another. A symmetrical hoist winch structure of this kind does not exert any bending forces on the lifting pylons, when the upper platform is lifted, but the lifting pylons only receive vertical forces produced by the lifting movement.

Preferably means for locking the upper platform into place comprise a latch closing each vertical gap, to which latches each rope tension equalizer will support in a locked position. The essential thing for the locked position of employment of the upper platform is that the symmetrically disposed winch arrangement as described above is not subjected to forces caused by lifting and holding up the upper platform. When the lifting pylons are additionally supported to the surrounding structure, the upper platform serves as it were an integral part of the construction.

### LIST OF FIGURES

The invention will now be described in greater detail by means of preferred embodiments and with reference to the accompanying drawings, in which:

FIG. 1 shows equipment of the invention for lifting a platform in the middle of a large construction;

FIG. 2 is a perspective view of a lifting rope arrangement associated with one pair of lifting pylons seen in FIG. 1, and a separate view of lifting machinery;

FIG. 3 shows in greater detail the winch arrangement of FIG. 2; and

FIG. 4 shows how the rope tension equalizer seen in FIG. 3 is connected to the pair of lifting pylons; and

FIG. 5 shows the operation of a locking latch.

### DETAILED DESCRIPTION OF THE INVENTION

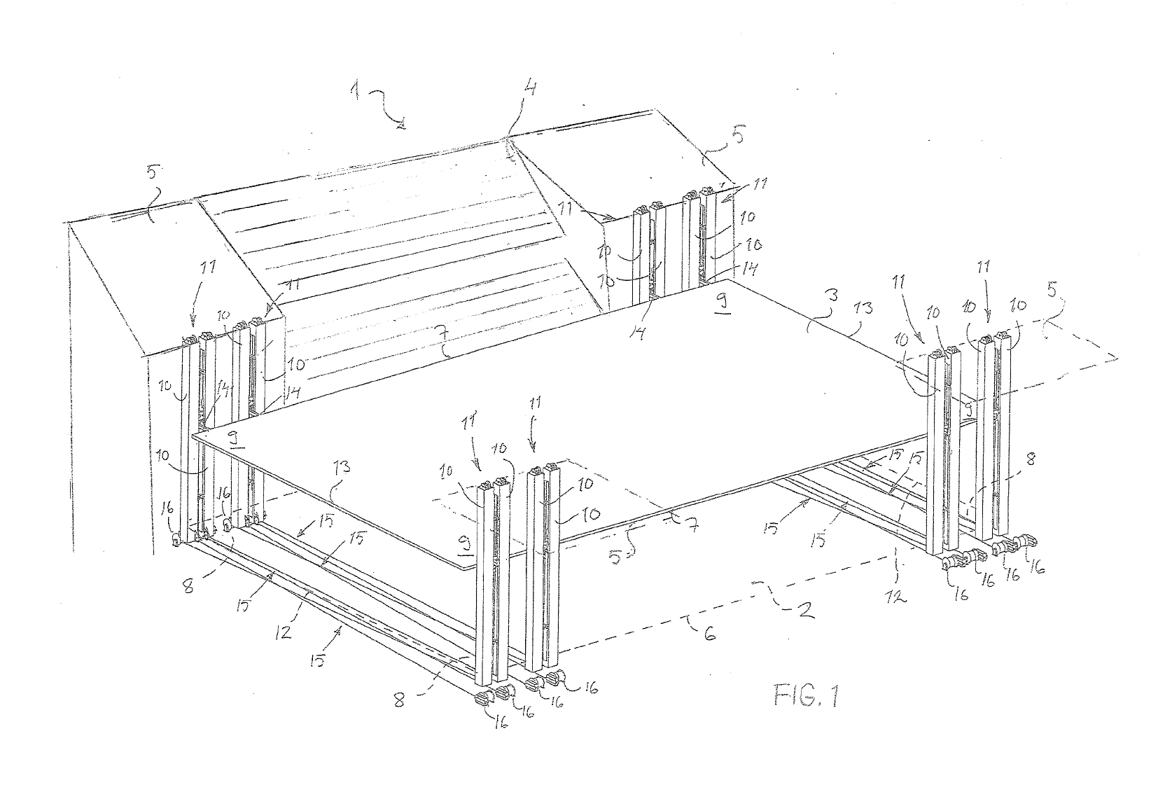

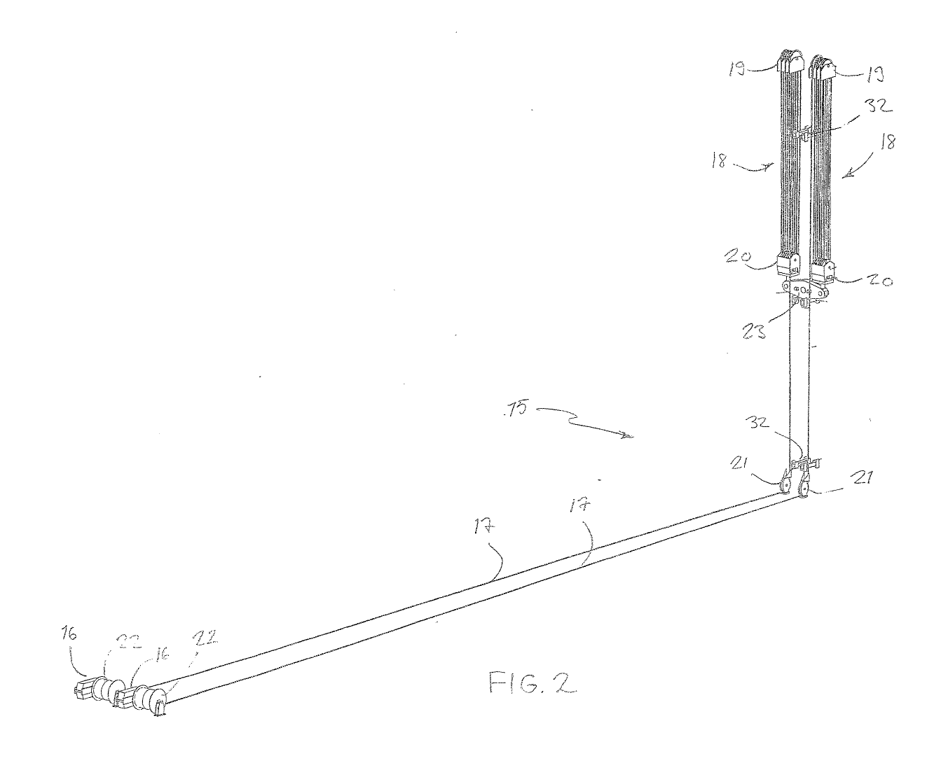

With reference to FIGS. 1 and 2, they show a construction 1 relating to the invention, in the middle of which construction there is a stationary, fixed, lower platform 2, and thereabove an upper platform 3 having an adjustable height position. The platforms 2 and 3 are surrounded by other spaces 4 of the construction 1 with their support structures 5. Here the platforms 2 and 3 are typically rectangular in shape, even though in the implementation of the invention the shape could just as well be round, oval or other than rectangular.

In this example, beside the two longer sides 6, 7, close to the corners 8, 9 of the platforms, there are arranged two lifting pylon pairs 11, each consisting of two lifting pylons 10. Thus, each lifting pylon 10 or lifting pylon pair 11 is supported to support structures 5 surrounding the platforms 2 and 3 of the construction 1.

Naturally, lifting pylons 10 or lifting pylon pairs 11 could also be beside the shorter sides 12, 13 of the platforms, close to the corners, and further at least at the middle of the longer sides 6, 7 of the platforms. The placement and number of the lifting pylons 10 or lifting pylon pairs 11 depend, of course, on the size, shape and mass of the platform 3.

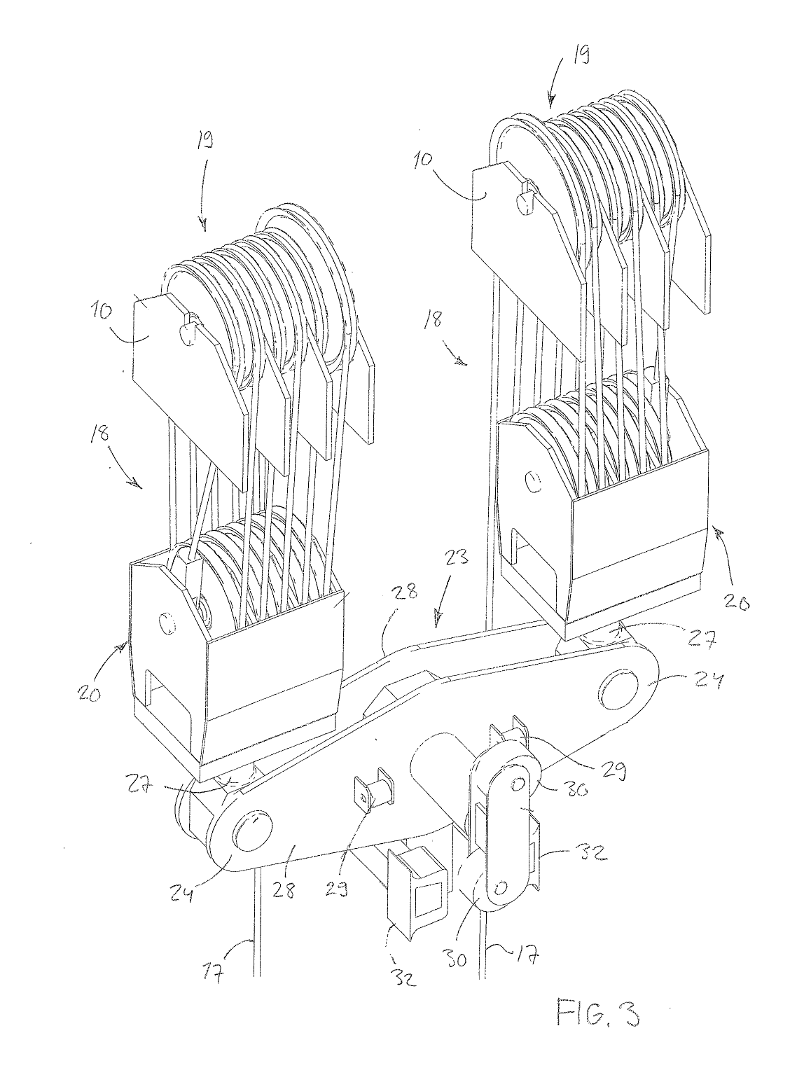

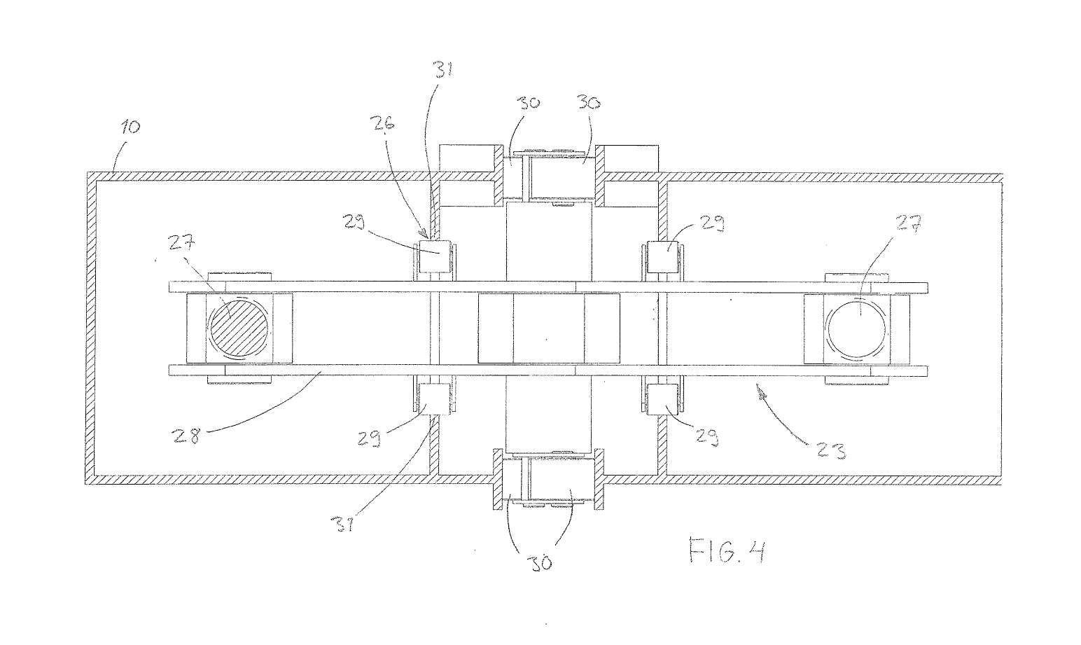

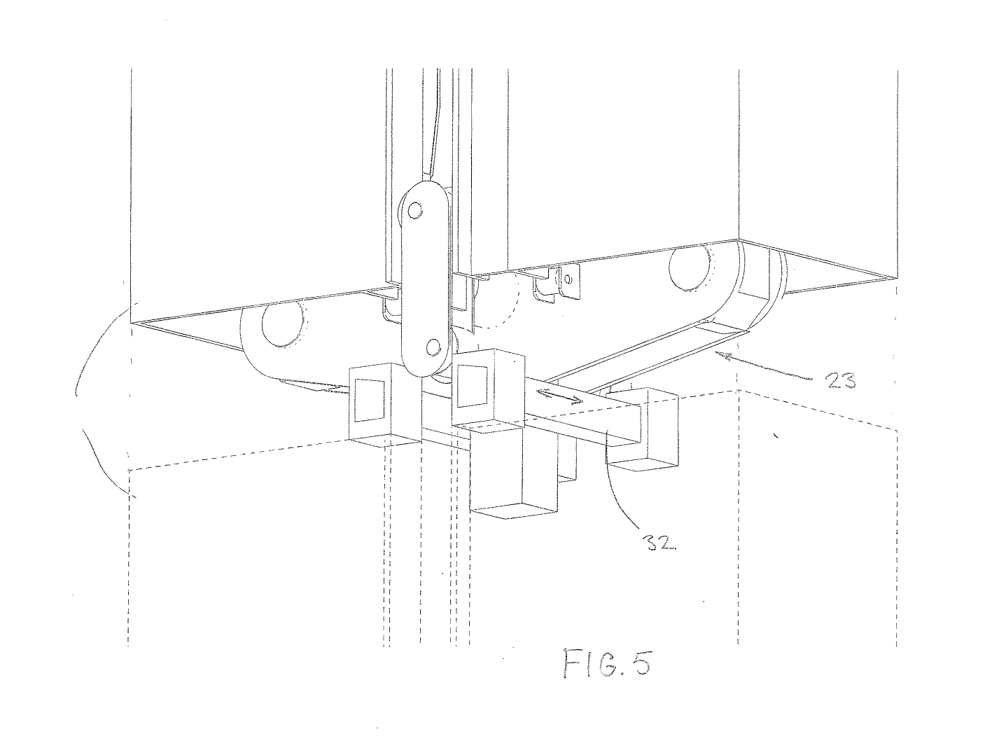

Further, with reference to FIGS. 2 to 5, the actual equipment for lifting the upper platform 3 comprises a lifting rope arrangement 15 arranged in each lifting pylon 10 and connected to lifting points 14 of the upper platform 3, lifting machines 16, connected to the lifting rope arrangements 15, for lifting and lowering the upper platform 3 by means of these lifting rope arrangements 15, and means to be described later for locking the upper platform 3 into place at a desired height position.

It is essential to the lifting equipment that the lifting machinery 16 driving the lifting rope arrangement 15 and arranged in each lifting pylon 10 is placed opposite to each particular lifting pylon 10 in question, on the sides of the platforms 2 and 3, in the implementation of the example described here, preferably, in relation to the lifting pylon 10 concerned, on the opposite side of the platforms 2 and 3 and below the level of the lower platform 2. In this example these lifting machines are placed in the vicinity of the lifting pylons 10 locating on the opposite side of the platforms 2 and 3 concerned, either behind them or below them.

Each lifting rope arrangement 15 comprises a lifting rope 17, a winch 18 disposed inside a lifting pylon 10 and having an upper rope pulley set 19, supported to the upper part of the lifting pylon 10 and locating above the uppermost locking point of the upper platform 3, and a lower rope pulley set 20, moving inside the lifting pylon 10 in vertical direction along with the lifting movement, via which the lifting rope 17 is guided to the lifting point 14 concerned of the upper platform 3, and a sheave 21 which is located below the level of the lower platform 2 and guides the lifting rope 17 towards the lifting machine 16 on the side of the opposite corner of the platforms 2 and 3. The rope pulley of the upper rope pulley set 19 which is first encountered by the lifting rope 17 coming from the sheave 21 is larger in diameter than the other rope pulleys of the winch 18 thus enabling vertical movement of the winch 18 without colliding with the lower rope pulley set 20.

When the lifting machines 16 are located in the above-described manner at a sufficient distance from the sheaves 21, the service life and winding on a rope drum 22 of the lifting rope 17 do not suffer from disadvantageous rope angles, whereby the lifting machine 16 and the rope drum 22 included therein may be secured fixedly to the foundations of the lifting pylon 10, which foundations are part of the support structures 5. When the sheave 21 is at a sufficient distance from the lifting machines 16, the sheave 21 may be attached in a fixed manner, without linkage allowing migration of the lifting rope 17, to be part of the support structures 5 in the vicinity of the lifting pylon 10 concerned.

In this example, the lifting pylon structure is provided in such a manner that two lifting pylons 10 form a lifting pylon pair 11 whose lifting pylons 10 are interconnected by means of lifting rope arrangements 15 disposed therein in such a manner that the lower rope pulley sets 20 of the winches 18 are interconnected through a rope tension equalizer 23 whose opposite ends 24 are guided to move in vertical gaps 26 provided in the walls 25 facing one another of the lifting pylons 10. The rope tension equalizer 23 is linked below the lower rope pulley sets 20 with articulations 27. In that case, for instance, the upper surface of the rope tension equalizer 23 serves as a support surface for the lifting point 14 of the upper platform 3. The articulations 27, in turn, equalize length differences in the lifting ropes 17 caused by lifting. A symmetrical hoist winch structure of this kind does not exert any bending forces on the lifting pylons 10, when the upper platform 3 is lifted, but the lifting pylons 10 only receive vertical forces.

In addition, on the opposite sides 28 of the rope tension equalizer 23 there are first and second guide rolls 29 and 30 that cooperate with the lifting pylon pair 11, the first guide rolls 29 supporting to the opposite lateral edges 31 of the vertical gap 26 and the second guide rolls 30 supporting to support surfaces 33 beside the walls 25 facing one another of the lifting pylons 10, on both sides of the vertical gap 26. It is characteristic to the guide rolls 29 and 30 that they receive deformations in the upper platform 3 and the surrounding structure 5 caused by wind and thermal stresses. A pair of rolls in the guide roll 30 is positioned such that the outer surfaces of the pair are in contact with the support surfaces 33 of the lifting pylon pair 11 on the opposite sides, enabling vertical movement in rolling contact. The disposition of the guide rolls 29 and 30 is characterized by symmetry, which enables application of forces with couples from a statically defined structure without bending moments loading the structures of the rope tension equalizer 23.

The rope tension equalizer 23 also acts as part of the locking of the upper platform 3, when it is locked to the height of employment. For locking, in connection with the lifting pylon pair 11, and optionally also supported to the surrounding structure 5, there is arranged a latch 32 which closes the vertical gap and to which the rope tension equalizer 23 supports in the locked position. The latch 32 is transferred, in the direction of arrows shown in FIG. 6, by using a separate transfer mechanism (not shown in the drawings) placed outside the lifting pylon pair 11. The travel provided by the transfer mechanism equals to the size of the vertical gap 26 in the lifting pylons 10, enabling vertical movement of the rope tension equalizer 23 when the latch is in an open position. In addition, the support surfaces 33 of the above-described guide rolls 30 in the lifting pylon pairs 11 are positioned in such a manner that the support structures (not shown) of the latch 32 do not block the vertical movement of the guide rolls 30.

The essential thing in the locked position of employment of the upper platform 3 is that the symmetrically disposed winch arrangement, as described above, is not subjected to forces caused by lifting and holding up the upper platform 3, when the locking is performed by the above-described static support of the rope tension equalizer 23 to the lifting pylon pair 11 and the latch 32. In that case the upper platform 3 serves as it were an integral part of the construction 1.

Lifting control of the upper platform 3 utilizes location data of the lifting points 14 of the upper platform 3, and motor control of the lifting machines 16 utilizes force data of the link support 27 of the lower rope pulley sets 20, whereby the platform 3 will be lifted while preserving its planar form. Preservation of the planar form of the upper platform 3, when lifted, is also enhanced by the fact that the lifting points 14 are located symmetrically on the edges of the platform 3 in similar structural parts of the platform 3.

The above description of the invention is only intended to illustrate the basic idea of the invention. It is obvious to a person skilled in the art, however, that the basic idea may be implemented in many different ways. The invention and its embodiments are thus not restricted to the examples described above, but they and the details thereof may vary, even considerably, within the scope of the accompanying claims. So, even though in the example shown in the drawings the lifting machinery, which drives the lifting rope arrangement disposed in each lifting pylon, is placed on the opposite side of the platforms in relation to the lifting pylon concerned, alternatively, they could be placed, for instance, on the platform sides on the same side with the lifting pylon concerned, even though this is not separately shown in the drawings.

1-12. (canceled)

13. Equipment for lifting and lowering a platform in the middle of a large construction, whereby the construction comprises a stationary, fixed, lower platform and an upper platform arranged thereabove and having an adjustable height position, the lifting equipment comprising a plurality of lifting pylons locating on the sides of the platforms, a lifting rope arrangement arranged for each lifting pylon and connected to the upper platform, lifting machines connected to the lifting rope arrangements for lifting and lowering the upper platform by means of the lifting rope arrangements, and means for locking the upper platform into place at a desired height position, wherein
the lifting machine driving the lifting rope arrangement disposed in each lifting pylon is placed on the opposite side of the platforms in relation to the lifting pylon concerned and below the level of the lower platform,
each lifting rope arrangement comprises a lifting rope, a winch having an upper rope pulley set and a lower rope pulley set, the upper rope pulley set locating above the uppermost locking point of the upper platform, and a sheave which is located under the level of the lower platform and guides the lifting rope towards the lifting machine on the opposite side of the platforms, and
at each lifting point of the upper platform there is a lifting pylon pair consisting of two lifting pylons, which lifting pylons are interconnected by means of lifting rope arrangements disposed therein in such a manner that the lower rope pulley sets of the winches are interconnected through a rope tension equalizer whose opposite ends are guided to move in vertical gaps provided in the walls facing one another of the lifting pylons.

14. The equipment of claim 13, wherein the lifting machinery driving the lifting rope arrangement disposed in each particular lifting pylon is placed in the vicinity of the lifting pylon concerned locating on the opposite side of the platforms, for instance, behind it or below it.

15. The equipment of claim 13, wherein the platforms are rectangular in shape, the lifting pylons being arranged adjacent to the longer sides of the platforms.

16. The equipment of claim 13, wherein the platforms are rectangular in shape, the lifting pylons being arranged adjacent to all sides of the platforms.

17. The equipment of claim 15, wherein the lifting pylons are arranged at least in the vicinity of the corners of the platforms.

18. The equipment of claim 15, wherein the lifting pylons are also arranged in the area between the corners.

19. The equipment of claim 13, wherein there is an even number of lifting pylons.

20. The equipment of claim 13, wherein on the opposite sides of the rope tension equalizer there are first and second guide rolls in cooperation with the lifting pylon pair, the first guide rolls supporting to the opposite lateral edges of the vertical gap and the second guide rolls supporting to the support surfaces on the sides of the walls facing one another of the lifting pylons, on both sides of the vertical gap.

21. The equipment of claim 20, wherein the means for locking the upper platform into place comprise a latch which closes each vertical gap and to which each rope tension equalizer is supported in the locked position.

22. The equipment of claim 13, wherein the lifting pylons are supported to a surrounding structure.
